(19) United States
(12) Patent Application Publication
(10) Pub. No.: US 2026/0351097 A1
(43) Pub. Date: Nov. 5, 2026

(54) Electronic Device With Sensor Indicators

(71) Applicant: Apple Inc., Cupertino, CA (US)

(72) Inventor: Paul X Wang, Cupertino, CA (US)

(21) Appl. No.: 19/641,144

(22) Filed: Apr. 7, 2026

Related U.S. Application Data
(60) Provisional application No. 63/798,446, filed on May 1, 2025.

(51) Int. Cl. G08B 5/22; G02B 27/01; G02C 11/00; H04N 23/56; H04N 23/57; H04N 23/667

(52) U.S. Cl. CPC G08B 5/22; G02B 27/0172; G02C 11/10; H04N 23/56; H04N 23/57; H04N 23/667; G02B 2027/0138; G02B 2027/0178

(57) ABSTRACT

A head-mounted device may include a head-mountable housing, such as a frame, and may have arms coupled to the frame. Lenses may be coupled to the head-mountable housing, and a user may view an exterior through the lenses. An optical sensor may be coupled to the head-mountable housing, and the optical sensor may be switched between an on state, in which the optical sensor measures an external object, and an off state. An indicator on the head-mounted housing may indicate when the optical sensor is in the on state. The indicator may be an optical indicator on an outer surface of the frame and/or may be a physical indicator on the outer surface of the frame. In this way, individuals at the exterior of the head-mounted device may be alerted as to whether the camera is active.

### CROSS REFERENCE TO RELATED APPLICATIONS

This application claims the benefit of U.S. provisional patent application No. 63/798,446, filed May 1, 2025, which is hereby incorporated by reference herein in its entirety.

### FIELD

This relates generally to systems that include electronic devices, such as head-mounted devices.

### BACKGROUND

Electronic devices, such as head-mounted devices, may have sensors for sensing an environment external to the devices. These sensors may include optical sensors or other sensors.

### SUMMARY

A head-mounted device may include a head-mountable housing, such as an eyeglasses frame, and may have eyeglasses arms coupled to the frame. Lenses may be coupled to the head-mountable housing, and a user may view an exterior through the lenses.

An optical sensor may be coupled to the head-mountable housing, and the optical sensor may be switched between an on state, in which the optical sensor measures an external object, and an off state. For example, the optical sensor may be a camera, and the camera may take images of the external object/external environment.

An indicator may be included on the head-mounted housing to indicate when the optical sensor is in the on state. The indicator may be an optical indicator on an outer surface of the frame and/or may be a physical indicator on the outer surface of the frame. For example, the indicator may be an e-ink layer, an electrochromic layer, an illumination region, a physical shutter, and/or another suitable indicator on the eyeglasses frame. In this way, individuals at the exterior of the head-mounted device may be alerted as to whether the camera is active.

### BRIEF DESCRIPTION OF THE DRAWINGS

FIG. 1 is a schematic diagram of an illustrative system in accordance with some embodiments.

FIG. 2 is a front view of an illustrative head-mounted device in accordance with some embodiments.

FIG. 3 is a front view of an illustrative head-mounted device with a camera and a lens in a frame in accordance with some embodiments.

FIG. 4 is a front view of an illustrative head-mounted device with an optical indicator formed from an electrically controlled layer in accordance with some embodiments.

FIG. 5 is a front view of an illustrative head-mounted device with an optical indicator formed from an electroluminescence wire in accordance with some embodiments.

FIGS. 6A and 6B are views of an illustrative head-mounted device with an optical indicator formed from a light emitter that illuminates a microperforation region in accordance with some embodiments.

FIGS. 7A-7D are views of an illustrative head-mounted device with an optical indicator formed from a light emitter that illuminates an illumination region in accordance with some embodiments.

FIGS. 8A and 8B are views of an illustrative head-mounted device with a physical indicator overlapping a camera in accordance with some embodiments.

FIG. 9 is a front view of an illustrative head-mounted device with a wire embedded in a frame to control cameras and indicators in the frame in accordance with some embodiments.

### DETAILED DESCRIPTION

Electronic devices such as head-mounted devices may include input-output devices, such as sensors, speakers, and/or displays. In some embodiments, head-mounted devices, such as goggles or glasses, may have lenses through which a user may see an exterior environment and may have a camera and/or microphone that may make measurements of the exterior environment.

To indicate that a sensor, such as a camera or microphone, in a head-mounted device is sensing the exterior environment, a head-mounted device may include a sensor indicator. For example, an e-ink, electrochromic, or liquid crystal layer on a front of the device may indicate to another person at the exterior that a camera is in use. Alternatively or additionally, lighting, such as lighting through a microperforation layer, light pipe, or diffuser, may be used to indicate that the camera is in use. As another example, a physical indicator, such as a manually or automatically adjustable shutter, may be used to indicate that the camera is in use. In this way, a person external to the electronic device may be aware that the camera is in use.

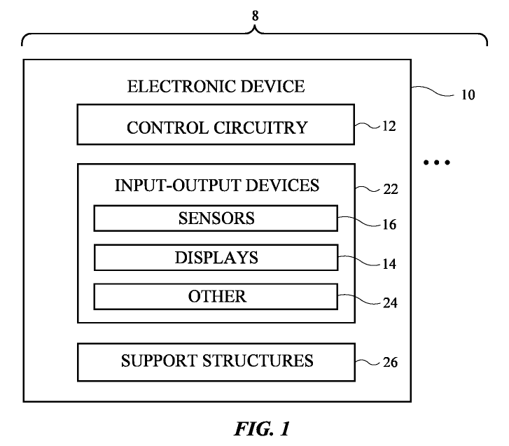

A schematic diagram of an illustrative system that may include a head-mounted device includes a sensor and a sensor indicator is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, system 8 may include one or more electronic devices such as electronic device 10. Electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WIFI® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device (e.g., a cellular telephone), a tablet, or laptop computer, online computing equipment such as a remote server or other remote computing equipment, or other electrical equipment) and/or to provide data to external equipment. For example, in some embodiments, some of the processing functionality of device 10 may be offloaded to another electronic device of system 8, and electronic device 10 may receive control signals directly from the other electronic device.

The communications circuitry may include antennas, radio-frequency transceiver circuitry, and other wireless communications circuitry and/or wired communications circuitry. The communications circuitry may, for example, support bidirectional wireless communications between devices 10 over a wireless link (e.g., a wireless local area network link, a near-field communications link, or other suitable wired or wireless communications link (e.g., a Bluetooth® link, a WiFi® link, a 60 GHz link or other millimeter wave link, etc.)). Devices 10 may also include power circuits for transmitting and/or receiving wired and/or wireless power (e.g., inductive power coils for transmitting and receiving wireless power) and may include batteries. In configurations in which wireless power transfer is supported between devices 10, in-band wireless communications may be supported using inductive power transfer coils (as an example).

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may optionally include one or more displays such as displays 14. In some configurations, device 10 includes left and right display devices (e.g., left and right components such as left and right projectors based on scanning mirror display devices, liquid-crystal-on-silicon display devices, digital mirror devices, or other reflective display devices, left and right display panels based on light-emitting diode pixel arrays (e.g., organic light-emitting display panels or display devices based on pixel arrays formed from crystalline semiconductor light-emitting diode dies), liquid crystal display panels, and/or or other left and right display devices) that provide images to left and right eye boxes for viewing by the user’s left and right eyes, respectively. Illustrative configurations in which device 10 has left and right display devices such as left and right projectors that provide respective left and right images for a user’s left and right eyes may sometimes be described herein as an example. In general, however, displays 14 may include any desired display technologies.

Displays 14 may be used to display visual content for a user of device 10. The content that is presented on displays 14 may include virtual objects and other content that is provided to displays 14 by control circuitry 12. This virtual content may sometimes be referred to as computer-generated content. Computer-generated content may be displayed in the absence of real-world content or may be combined with real-world content. For example, an optical coupling system may be used to allow computer-generated content to be optically overlaid on top of a real-world image. In particular, device 10 may have a see-through display system that provides a computer-generated image to a user through a beam splitter, prism, holographic coupler, diffraction grating, or other optical coupler (e.g., an output coupler on a waveguide that is being used to provide computer-generated images to the user) while allowing the user to view real-world objects through the optical coupler and other transparent structures (e.g., transparent waveguide structures, vision-correction lenses and/or other lenses, etc.). Alternatively, device 10 may have a pass-through display system, in which the external environment is imaged by a camera or other optical device, displayed on displays 14, and optionally augmented with virtual content. However, these examples are merely illustrative. In some embodiments, display 14 may be omitted from device 10.

Input-output devices 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user’s eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, color sensors (e.g., color ambient light sensors or cameras that detect light), microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), strain gauge sensors, and/or other sensors.

User input and other information may be gathered using sensors and other input devices in input-output devices 22. If desired, input-output devices 22 may include other components 24 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, microphones, buttons, and/or other components. Haptic output devices can produce motion that is sensed by the user (e.g., through the user’s fingertips or other body part). Haptic output devices in devices 10 may include actuators such as electromagnetic actuators such as solenoids, motors, piezoelectric actuators, electroactive polymer actuators, vibrators, linear actuators, rotational actuators, actuators that bend bendable members, actuator devices that create and/or control repulsive and/or attractive forces between devices 10 (e.g., components for creating electrostatic repulsion and/or attraction such as electrodes, components for producing ultrasonic output such as ultrasonic transducers, components for producing magnetic interactions such as electromagnets for producing direct-current and/or alternating-current magnetic fields, permanent magnets, magnetic materials such as iron or ferrite, and/or other circuitry for producing repulsive and/or attractive forces between devices 10).

Electronic device 10 may have housing structures as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, a glasses frame, arms or temples in a pair of eyeglasses, goggle housing structures, and/or other head-mounted structures). A head-mounted support structure may be configured to be worn on a head of a user during operation of device 10 and may support displays 14, sensors 16, other components 24, other input-output devices 22, and/or control circuitry 12. In an illustrative embodiment, electronic device 10 may be an eyeglasses device (also referred to a glasses device or smart glasses device herein) that includes a frame in which lenses and input-output devices 22 (e.g., a camera, a microphone, and/or a speaker) are mounted. Support structures 26 may therefore include arms/temples that extend from the frame to support device 10 (e.g., on ears of the user) while device 10 is worn by the user.

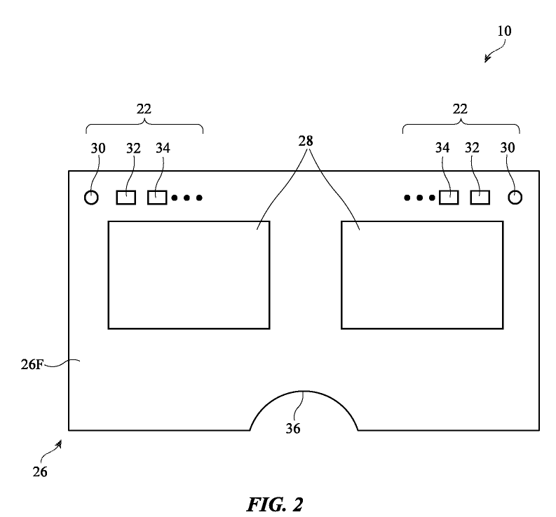

FIG. 2 is a front view of electronic device 10 in an illustrative configuration in which electronic device 10 is a head-mounted device. As shown in FIG. 2, electronic device 10 may include head-mounted support structures 26 to house the components of device 10 and to support device 10 on a user’s head. Support structures 26 may include, for example, structures that form housing walls and other structures at the front of device 10 (sometimes referred to as a frame, lens support frame, glasses frame, eyeglasses frame, etc.). In particular, support structures 26 may include frame 26F (also referred to as eyeglasses frame 26F herein) at the front of device 10. Support structures 26 may include additional structures such as straps, glasses arms/temples, or other supplemental support structures that help to hold the frame and the components in the frame on a user’s face. If desired, support structures 26 may include hinges between frame 26F and arms/temples of support structures 26 (e.g., so that the arms of device 10 can be folded parallel to the frame at the front of device 10 when not in use). Support structures 26 may be formed from metal, plastic, resin, polymer, and/or any other suitable material(s).

Lenses 28 may be mounted in frame 26F on either side of nose bridge 36, which may support frame 26F on a nose of the user when device 10 is worn. Lenses 28 may be, for example, transparent lenses formed from glass, polycarbonate, acrylic, and/or other suitable material(s). Lenses 28 may have an associated lens power (e.g., a prescription lens power between +20.0 diopter and -20.0 diopter) and/or may have additional prescription lens correction (e.g., a spherical and/or cylindrical lens correction). Alternatively, one or both of lenses 28 may have no power correction (e.g., a power correction of zero diopter) and/or may have no additional prescription lens correction (e.g., no spherical and/or cylindrical lens correction). In general, a user of device 10 may see through lenses 28 to view an external environment (e.g., an exterior) around device 10.

Although lenses 28 are described as being transparent, this is merely illustrative. In general, lenses 28 may have any suitable transparencies. For example, lenses 28 may be tinted to provide ultraviolet (UV) protection for a wearer of device 10. Lenses 28 may be passively (e.g., permanently) tinted or actively tinted (e.g., using an electronic light modulator layer, such as a liquid crystal layer).

Input-output devices 22 may also be formed in frame 26F. In the illustrative example of FIG. 2, input-output devices 22 include cameras 30, microphones 32, and speakers 34. However, this is merely illustrative. In general, input-output devices 22 may include any suitable device(s) coupled to frame 26F and/or coupled to any other suitable portion of support structures 26 (e.g., eyeglasses arms of support structures 26).

Cameras 30 may be visible-light cameras, infrared-light cameras, and/or cameras that generate images in response to any other suitable wavelengths of light. Microphones 32 may detect audio input from the exterior of device 10 and/or from the user of device 10 (e.g., in the form of audio commands). Speakers 34 may emit sound to a user of device 10 and/or to people at the exterior of device 10. Although FIG. 2 shows two sets of cameras 30, microphones 32, and speakers 34, this is merely illustrative. In general, device 10 may include any suitable number of cameras, microphones, speakers, and/or other input-output devices 22, such as one or more of each device.

In an illustrative operation, a user of device 10 may wear device 10 and view the external environment through lenses 28. The user may issue a voice command (or provide other input, such as a tap, touch, button press, etc.) to device 10 (or to another device in system 8) to record using camera(s) 30 and microphone(s) 32. Camera(s) 30 and microphone(s) 32 may then record the external environment for a predetermined period of time and/or until the user provides another command/input to stop recording. Alternatively or additionally, a user of device 10 may use camera(s) 30 to capture a portion of the external environment, and device 10 may provide the user with information regarding the portion of the external environment.

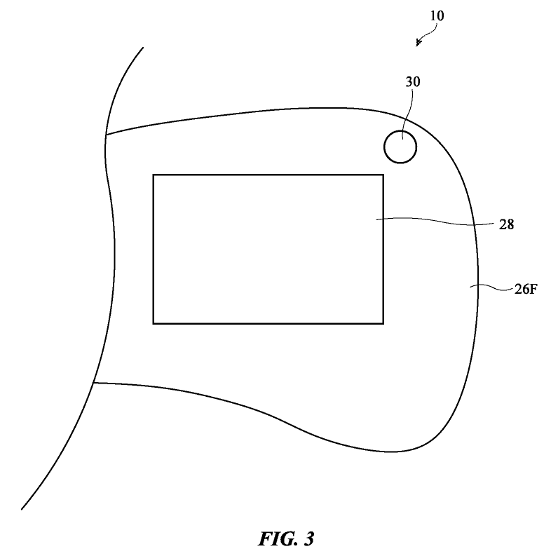

Regardless of how camera(s) 30 and/or microphone(s) 32 are used, it may be desirable to provide an indication to individuals at the exterior of device 10 that they are being recorded using camera(s) 30 and/or microphone(s) 32. For example, an optical indicator and/or physical indicator may be used to indicate when cameras and/or microphones in device 10 are in use. The indicator may have a first appearance when the cameras/microphones are off and a second, different appearance when the cameras/microphones are on. An illustrative example of device 10 when the cameras/microphones are off is shown in FIG. 3.

As shown in FIG. 3, frame 26F may have a first appearance when camera 30 is turned off (e.g., when camera 30 is not recording). For example, frame 26F may have a desired color and/or pattern when camera 30 is turned off.

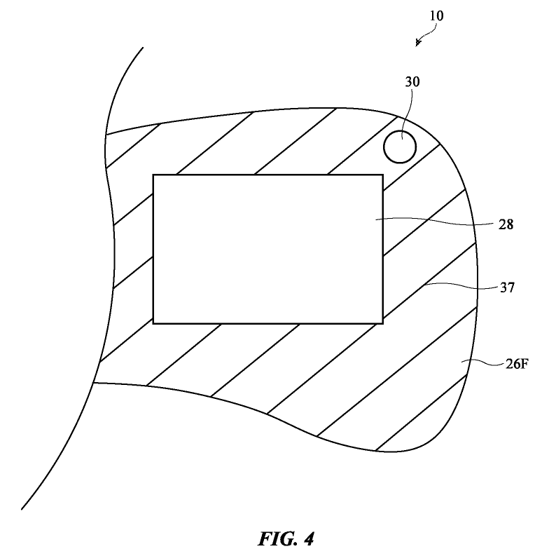

In contrast, as shown in FIG. 4, frame 26F may have a second appearance that is different from the first appearance (FIG. 3) when camera 30 is turned on (e.g., when camera 30 is recording). For example, frame 26F may have a different color, pattern, and/or other appearance characteristic (indicated by hatching 37) to indicate to an individual at the exterior of device 10 that camera 30 is in use.

The appearance of frame 26F may be changed using an electrically controlled layer, such as an e-ink layer (e.g., a black and white e-ink layer or a color e-ink layer), an electrochromic layer, a liquid crystal layer, or another suitable layer. The electrically controlled layer may be formed on an outer surface of frame 26F (e.g., on a surface of frame 26F adjacent to the exterior of device 10) or may be formed within frame 26F (e.g., the electrically controlled layer may be overlapped by a transparent outer layer of frame 26F).

In an illustrative embodiment, frame 26F may be changed to have a green appearance (or another suitable color) to indicate that camera 30 is in use. Alternatively or additionally, frame 26F may be patterned (e.g., with a striped pattern) and/or pulsed, flashed, or otherwise modulated to indicate that camera 30 is in use. In this way, the electrically controlled layer in/on frame 26F may be used to optically indicate that camera 30 is in use.

If desired, an electrically controlled layer in frame 26F may additionally be used to personalize the appearance of frame 26F. For example, a user of device 10 may adjust the electrically controlled layer to personalize the color, pattern, and/or another appearance characteristic of frame 26F.

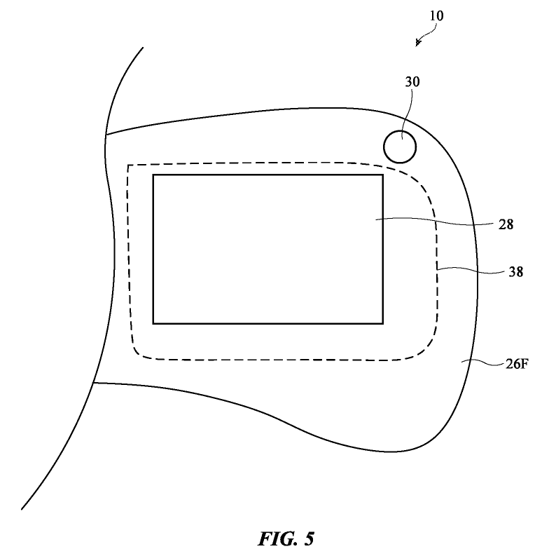

Alternatively or additionally to incorporating an electrically controllable layer in/on frame 26F, an illumination component may be incorporated into frame 26F to indicate that camera 30 is active. For example, an electroluminescence wire may be formed in frame 26F. An illustrative example is shown in FIG. 5.

As shown in FIG. 5, electroluminescence wire 38 may be formed in frame 26F. For example, electroluminescence wire 38 may be embedded within frame 26F. Electroluminescence wire 38 may be, for example, a copper wire coated with a phosphor. Current may be applied to electroluminescence wire 38 to produce light using the phosphor. In particular, when camera 30 is in use, electroluminescence wire 38 may be activated to produce light and indicate that camera 30 is on. Alternatively or additionally, electroluminescence wire 38 may be pulsed, flashed, or otherwise modulated to indicate that camera 30 is on. In this way, electroluminescence wire 38 may provide an optical indicator that camera 30 has been activated.

In the example of FIG. 5, electroluminescence wire 38 extends entirely around lens 28. However, this arrangement is merely illustrative. In general, electroluminescence wire 38 may be incorporated into any suitable portion(s) of frame 26F. For example, one or more electroluminescence wires 38 may at least partially surround one or both lenses 28. Alternatively or additionally, one or more electroluminescence wires 38 may at least partially surround one or both cameras 30 and/or may run along a periphery of frame 26F.

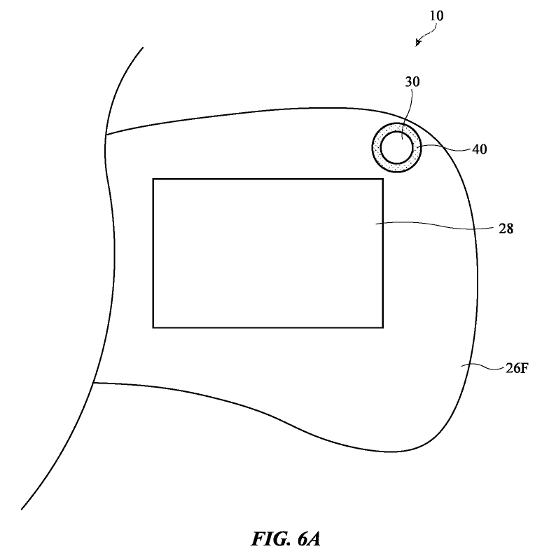

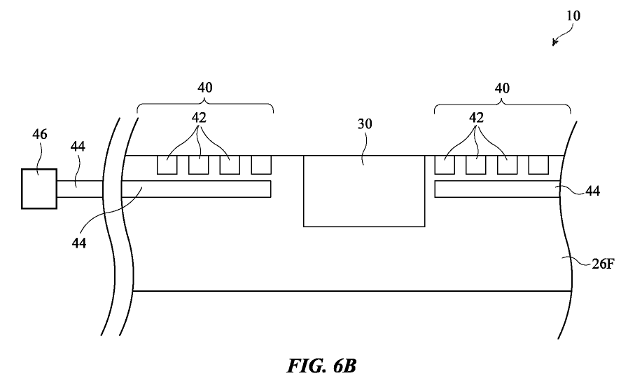

Alternatively or additionally to using an electroluminescence wire to provide lighting to indicate that camera 30 is in use, a light emitter, such as a light-emitting diode may emit light out of frame 26F to indicate that camera 30 is activated. An illustrative example is shown in FIG. 6A.

As shown in FIG. 6A, frame 26F may include microperforation region 40 surrounding camera 30. Although FIG. 6A shows microperforation region 40 completely surrounding camera 30, microperforation region 40 may at least partially surround camera 30 (e.g., a sensor window in frame 26F that overlaps camera 30), or microperforation region 40 may be formed in another suitable portion of frame 26F.

One or more light sources in frame 26F (or otherwise in support structures 26) may emit light through microperforation region 40. As shown in the illustrative example of FIG. 6B, microperforation region 40 may include microperforations 42 in a surface of frame 26F. Microperforations 42 may be openings with diameters (widths) of less than 100 microns, less than 50 microns, less than 10 microns, between one micron and 20 microns, or other suitable widths.

Microperforations 42 may overlap one or more light pipes 44. Light pipe(s) 44 may guide light emitted by light emitter 46 to be microperforation region 40, where the light may be emitted to the exterior of frame 26F. Light emitter 46 may be a light-emitting diode or another suitable light source formed in a portion of frame 26F or another portion of support structures 26. Light pipe(s) 44 may be formed from a transparent material, such as polycarbonate, and may guide the light emitted by light emitter 46 to microperforation region 40.

Light emitter 46 may be turned on when camera 30 is on, thereby emitting light through microperforation region 40 to indicate that camera 30 is active. When camera 30 is turned off, light emitter 46 may similarly be turned off to indicate that camera 30 is inactive. In this way, the illuminated microperforation region 40 (and light emitter 46) may form an optical indicator on frame 26F of whether camera 30 is turned on.

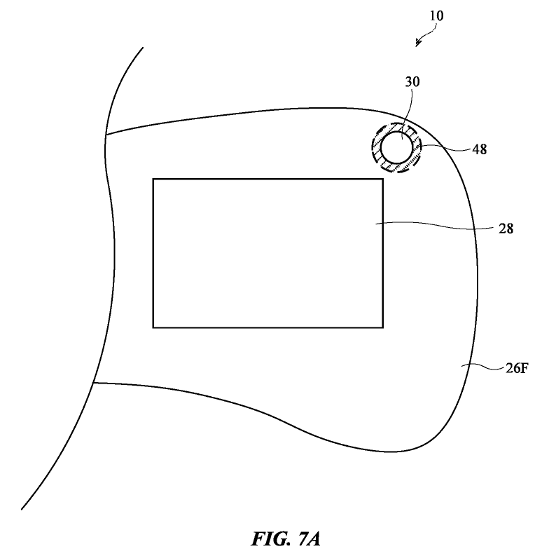

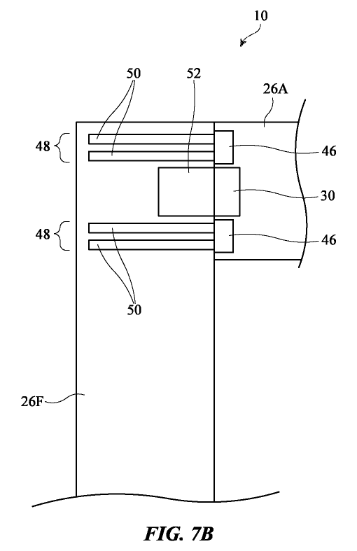

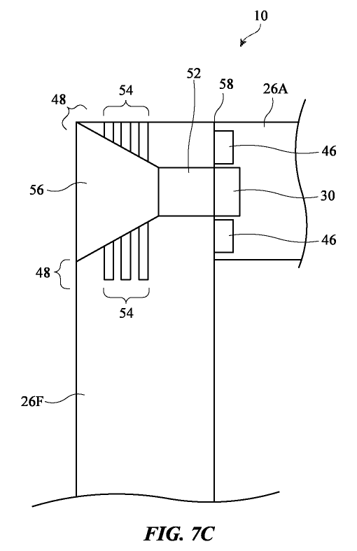

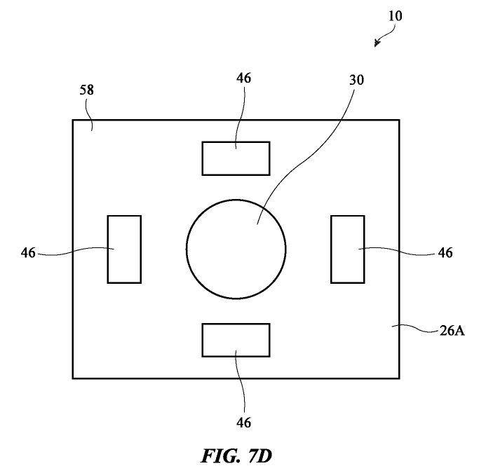

Although FIG. 6B shows camera 30 mounted in frame 26F, this is merely illustrative. In general, camera 30, as well as an indicator indicating whether camera 30 is turned on, may be formed in any suitable support structure and may be visible at the exterior of frame 26F. For example, one or more components may be formed in an eyeglasses arm that is attached to frame 26F. An illustrative example is shown in FIG. 7A.

As shown in FIG. 7A, frame 26F may include illumination region 48 surrounding camera 30 (e.g., surrounding a camera window in frame 26F that overlaps camera 30). Although FIG. 7A shows illumination region 48 completely surrounding camera 30, illumination region 48 may at least partially surround camera 30, or illumination region 48 may be formed in another suitable portion of frame 26F.

One or more light sources in frame 26F (or otherwise in support structures 26) may emit light through illumination region 48. As shown in the illustrative example of FIG. 7B, illumination region 48 may include light pipes 50 in frame 26F. Light pipes 50 may be formed from polycarbonate or other suitable material, and light pipes 50 may be embedded in frame 26F.

Arm 26A (also referred to as eyeglasses arm 26A) may be coupled to frame 26F at surface 58. Arm 26A may extend from frame 26F and may rest on a user’s ear, thereby allowing device 10 to be worn by the user. One or more light emitters 46 and camera 30 may be coupled to/mounted on arm 26A.

When arm 26A is coupled to frame 26F, the one or more light emitters 46 are aligned with light pipes 50. Similarly camera 30 may be aligned with camera window 52 of frame 26F. Camera window 52 may be a hole in frame 26F and/or may be formed from transparent material to allow camera 30 to take images of the environment around device 10.

When camera 30 is turned on, light emitter(s) 46 may emit light through light pipes 50 to illuminate illumination region 48 and indicate that camera 30 is in use. When camera 30 is turned off, light emitter(s) 46 may be turned off. In this way, illumination region 48 (and light emitter(s) 46) may form an indicator to indicate whether camera 30 is active.

By forming camera 30 and light emitter(s) 46 in arm 26A, there may be no need for wires, circuitry, and/or other electronic components in frame 26F to control camera 30 and light emitter(s) 46. Instead, all of the associated wires, circuitry, and/or other electronic components to control camera 30 and light emitter(s) 46 may be formed in arm 26A. If desired, arm 26A may be removably coupled to frame 26F, allowing arm 26A to be replaced with another arm 26A, if desired.

In FIG. 7B, illumination region 48 is shown as including light pipes 50. However, this is merely illustrative. In general, any suitable optical layer may be incorporated into frame 26F to form illumination region 48. For example, a diffuser may be used. An illustrative example is shown in FIG. 7C.

As shown in FIG. 7C, illumination region 48 in frame 26F may be formed using diffuser 54. Diffuser 54 may diffuse light with a maximum angle of at least 15°, at least 20°, at least 25°, at least 30°, at least 40°, between 10° and 50°, at least 60°, less than 80°, or another suitable angle. By diffusing the light emitted by light emitter(s) 46, diffuser 54 may form illumination on illumination region 48 of frame 26F.

Frame 26F may optionally also include window 56 that overlaps window 52 and camera 30. Window 56 may be an opening or may be formed from transparent material to allow camera 30 to operate through frame 26F.

An illustrative front view of light emitters and a camera on an eyeglasses arm that can be attached to an eyeglasses frame is shown in FIG. 7D.

As shown in FIG. 7D, light emitters 46 and camera 30 may be formed on surface 58 of arm 26A. Therefore, when arm 26A is attached to frame 26F, light emitters 46 may emit light through frame 26F, and camera 30 may operate through frame 26F.

Although FIG. 7D shows four light emitters 46 and one camera 30 on surface 58 of arm 26A, this is merely illustrative. In general, any suitable number of light emitters and/or cameras may be formed on arm 26A, such as at least one light emitter and at least one camera.

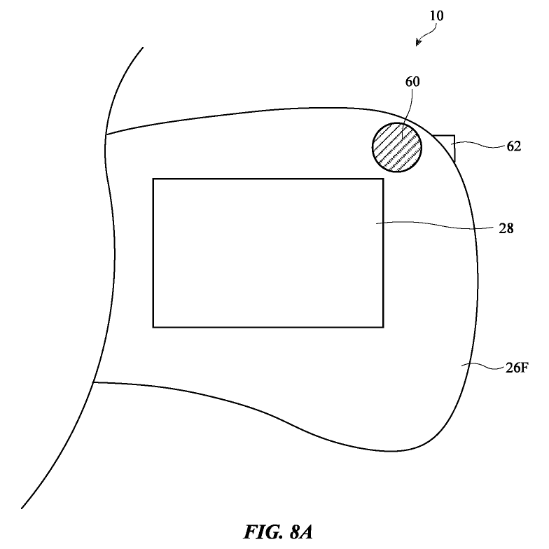

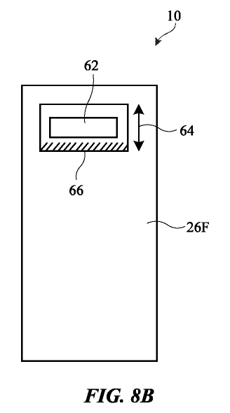

Instead of, or in addition to, including an optical indicator on device 10 to indicate when camera 30 is in use, a physical indicator may be used. An illustrative example is shown in FIG. 8A.

As shown in FIG. 8A, physical indicator 60 may cover a camera (e.g., camera 30) when camera 30 is not in use. For example, physical indicator 60 may be a shutter that overlaps the camera. Physical indicator 60 may be formed from metal, plastic, or other suitable material. In some embodiments, physical indicator 60 may include a reflector layer, a high contrast colored layer (e.g., a yellow or green layer), a textured layer, and/or an X to indicate to an individual at the exterior of device 10 that the camera is not in use. In other words, physical indicator 60 may cover the camera, rendering the camera unable to capture images of the exterior, while indicating that the camera is not in use.

Physical indicator 60 may be controlled using switch 62. In other words, physical indicator 60 may be a manual shutter controlled by switch 62. As shown in FIG. 8B, switch 62 may be on a side of frame 26F and may be movable in directions 64. By toggling switch 62 in directions 64, physical indicator 60 may be switched from a closed position in which an underlying camera is covered (e.g., as shown in FIG. 8A) and an open position in which the underlying camera is uncovered (e.g., as shown in FIG. 3). In this way, a user may adjust switch 62 depending on whether it is desired to capture images of the exterior using the camera.

If desired, switch 62 may include additional indicator 66. For example the cavity in which switch 62 is formed may have a color (e.g., an orange or green color) or pattern to form indicator 66. When switch 62 is in a first position, indicator 66 may be visible. When switch 62 is in a second position, indicator 66 may be hidden beneath switch 62. In this way, additional indicator 66 may indicate the position of switch 62 and therefore whether the camera is in use.

Although FIGS. 8A and 8B show switch 62 being used to manually control the position of physical indicator 60, this is merely illustrative. In some embodiments, device 10 may include an actuator, such as a motor, in a portion of supporting structures 26 (e.g., in frame 26F). The actuator may move physical indicator 60 based on whether the underlying camera is to be used. In this way, physical indicator 60 may be an automatic shutter that is opened and closed using an actuator based on whether the camera is in the on state or in the off state, respectively.

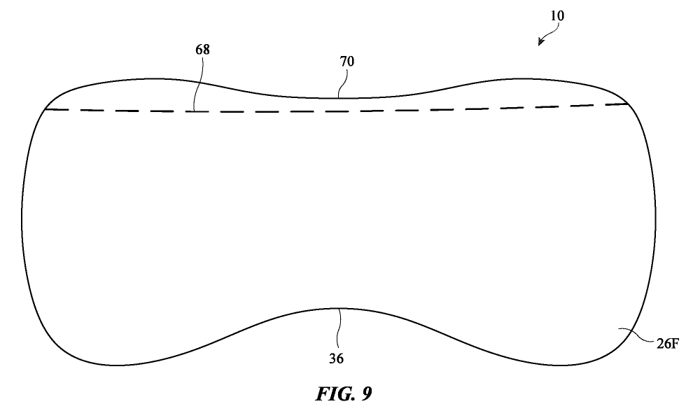

Regardless of the type of indicator that is used to indicate that a camera is in use, device 10 may include circuitry to control the indicator, the camera, and/or other components in device 10. An illustrative example is shown in FIG. 9.

As shown in FIG. 9, device 10 may include wire 68 embedded in frame 26F. Wire 68 may be formed from metal or other conductive material, and wire 68 may run along (e.g., adjacent to) peripheral edge 70 of frame 26F, opposite nose bridge 36.

Wire 68 may couple control circuitry in device 10, such as control circuitry 12 (FIG. 1), to one or more components in device 10, such as camera 30, microphone 32, and/or speaker 34 (FIG. 2), and/or one or more indicators. For example, wire 68 may be coupled to the electrically controlled (e.g., e-ink or electrochromic) layer of FIG. 4, the electroluminescence wire of FIG. 5, light emitter 46 of FIGS. 6B or 7B/C , and/or physical indicator 60 of FIG. 8A. In this way, control circuitry 12 may activate one or more indicators to indicate that camera(s) 30 are on. Alternatively, control circuitry 12 may activate camera(s) 30 over wire 68, and camera(s) 30 may be directly wired to one or more indicators. In other words, the one or more indicators may be automatically activated when camera(s) 30 are activated.

Although FIGS. 3-9 have shown and described an indicator for indicating whether a camera (e.g., camera 30) in a head-mounted device is on, this is merely illustrative. Alternatively or additionally to indicating that a camera is on, any of the indicators shown in FIGS. 3-8 may be used to indicate that a microphone (e.g., microphone 32 of FIG. 2) or another sensor is on. For example, an electrically controlled layer, such as the electrically controlled layer of FIG. 4, may display a dedicated color and/or pattern when camera 30 is activated (e.g., activated along with microphone 32) and may display a different dedicated color and/or pattern when microphone 32 is activated without camera 30. Similarly, any of the light-based indicators of FIGS. 5-7 may display a dedicated color and/or pattern when camera 30 is activated (e.g., activated along with microphone 32) and may display a different dedicated color and/or pattern when microphone 32 is activated without camera 30. However, this is merely illustrative. Additional sensors, such as microphone 32, in device 10 may have dedicated indicators, if desired. In this way, one or more indicators in device 10 may indicate whether camera 30 and/or microphone 32 are activated.

Additionally, although FIGS. 3-9 have shown an indicator formed on an outer (front) surface of a head-mounted device. This is merely illustrative. In general, an indicator may be formed on any suitable surface(s) of a head-mounted device, such as a peripheral edge of a frame, an outer surface of an arm, etc.

System 8 (e.g., device 10) may gather and use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A head-mounted device configured to sense an external object, the head-mounted device comprising:
a head-mountable housing;
lenses coupled to the head-mountable housing;
an optical sensor coupled to the head-mountable housing, wherein the optical sensor is configured to be switched between an on state and an off state; and
an indicator coupled to the head-mounted housing, wherein the indicator is configured to indicate when the optical sensor is in the on state.

2. The head-mounted device of claim 1, wherein the head-mountable housing comprises an eyeglasses frame, and the indicator comprises an optical indicator on a surface of the eyeglasses frame.

3. The head-mounted device of claim 2, wherein the optical indicator comprises an e-ink layer.

4. The head-mounted device of claim 2, wherein the optical indicator comprises an electroluminescence wire that at least partially surrounds one of the lenses.

5. The head-mounted device of claim 2, wherein the eyeglasses frame comprises a microperforation region at least partially surrounding the optical sensor, and the optical indicator comprises a light emitter that is configured to emit light through the microperforation region.

6. The head-mounted device of claim 2, wherein the head-mountable housing further comprises an arm coupled to the eyeglasses frame, the optical sensor is mounted on the arm, the eyeglasses frame comprises an optical layer, and the optical indicator comprises a light emitter mounted on the arm that is configured to emit light through the optical layer.

7. The head-mounted device of claim 6, wherein the optical layer comprises a light pipe.

8. The head-mounted device of claim 6, wherein the optical layer comprises a diffuser.

9. The head-mounted device of claim 1, wherein the head-mountable housing comprises an eyeglasses frame, and the indicator comprises a physical indicator on a surface of the eyeglasses frame.

10. The head-mounted device of claim 9, wherein the physical indicator comprises a manual shutter, and the head-mounted device further comprises a switch configured to open and close the manual shutter.

11. The head-mounted device of claim 9, wherein the physical indicator comprises an automatic shutter, and the head-mounted device further comprises an actuator configured to open and close the automatic shutter in response to the optical sensor being switched between the on state and the off state.

12. The head-mounted device of claim 1, wherein the head-mountable housing comprises an eyeglasses frame with a peripheral edge, the head-mounted device comprises a wire that runs along the peripheral edge, and the wire is coupled to the indicator.

13. The head-mounted device of claim 12, wherein the wire is further coupled to the optical sensor.

14. An eyeglasses device configured to detect an object at an exterior, the eyeglasses device comprising:
a frame;
arms coupled to the frame;
lenses mounted in the frame;
an optical sensor coupled to the frame and configured to detect the object at the exterior; and
an indicator coupled to the frame, wherein the indicator is configured to indicate when the optical sensor is activated.

15. The eyeglasses device of claim 14, wherein the indicator comprises a light source configured that is configured to turn on when the optical sensor is activated.

16. The eyeglasses device of claim 15, wherein the frame comprises an optical layer, the light source is mounted on one of the arms, and the light source is configured to emit light through the optical layer when the light source is turned on.

17. The eyeglasses device of claim 14, wherein the indicator comprises a shutter.

18. The eyeglasses device of claim 14, wherein the indicator comprises an e-ink layer on a surface of the frame facing the exterior.

19. A head-mounted device configured to sense an object at an exterior, the head-mounted device comprising:
a frame;
lenses mounted in the frame;
a camera coupled to the frame, wherein the camera is configured to be switched between an on state and an off state; and
an optical indicator coupled to the frame, wherein the optical indicator is configured to display an indication on a surface of the frame when the camera is in the on state.

20. The head-mounted device of claim 19, wherein the optical indicator comprises an e-ink layer on the surface of the frame.
